(19) United States
(12) Patent Application Publication
(10) Pub. No.: US 2026/0169487 A1
(43) Pub. Date: Jun. 18, 2026

(54) AUTONOMOUS MOVING BODY CONTROL SYSTEM, AUTONOMOUS MOVING BODY CONTROL METHOD, AND STORAGE MEDIUM

(71) Applicant: TOYOTA JIDOSHA KABUSHIKI KAISHA, Toyota-shi (JP)

(72) Inventor: Shintaro YOSHIZAWA, Toyota-shi (JP)

(73) Assignee: TOYOTA JIDOSHA KABUSHIKI KAISHA, Toyota-shi (JP)

(21) Appl. No.: 19/397,014

(22) Filed: Nov. 21, 2025

(30) Foreign Application Priority Data
Dec. 18, 2024 (JP) 2024-221650

(51) Int. Cl. G05D 1/622; G05D 1/689; G05D 109/10; G05D 111/10; G06T 7/60

(52) U.S. Cl. CPC G05D 1/622; G05D 1/689; G06T 7/60; G05D 2109/10; G05D 2111/10

(57) ABSTRACT

An autonomous moving body control system that causes an autonomous moving body to travel, and reproduces a three-dimensional shape of an object in a region includes a traveling control unit causing the autonomous moving body to travel in the region along a created route, an information acquisition unit acquiring the three-dimensional shape of the object measured by a sensor of the autonomous moving body, and a route changing unit that changes the route where the autonomous moving body travels in the region, such that the autonomous moving body approaches the object, based on the three-dimensional shape of the object acquired, in which the traveling control unit causes the autonomous moving body to travel in the region along the changed route, and the information acquisition unit acquires the three-dimensional shape of the object measured by the sensor while the autonomous moving body is traveling in the region along the changed route.

### CROSS-REFERENCE TO RELATED APPLICATION

This application claims priority to Japanese Patent Application No. 2024-221650 filed on Dec. 18, 2024. The disclosure of the above-identified application, including the specification, drawings, and claims, is incorporated by reference herein in its entirety.

### BACKGROUND

### 1. Technical Field

The present disclosure relates to an autonomous moving body control system, an autonomous moving body control method, and a storage medium.

### 2. Description of Related Art

An autonomous moving body that is equipped with a sensor for measuring three-dimensional shapes of objects is made to travel, so as to reproduce three-dimensional shapes of objects in a particular region.

Japanese Unexamined Patent Application Publication No. 2010-170288 (JP 2010-170288 A) discloses a three-dimensional modeling device that causes an autonomous moving body, equipped with a sensor that can rotate 360 degrees in a horizontal direction and move heightwise in an up-down direction, to travel, and thereby obtains a three-dimensional model represented by a set of point clouds based on modeling sensor data acquired at a plurality of positional points and a three-dimensional position of the sensor when the data was acquired.

### SUMMARY

When distance between the sensor that measures a three-dimensional shape and an object is too close, error is likely to occur in the measured three-dimensional shape, and accordingly a certain distance or more is considered to be necessary between the sensor and the object. However, when measurements are taken from a distance, and the three-dimensional shape of the object is complicated, the result may be that the three-dimensional shape is unmeasurable, or reproduction to an accurate three-dimensional shape is unachievable, and it may be necessary to cause the autonomous moving body to travel again to take measurements.

The present disclosure solves these problems, and provides an autonomous moving body control system, an autonomous moving body control method, and a program that adjusts distance between an autonomous moving body and an object, in accordance with a three-dimensional shape of the object, thereby efficiently and accurately reproducing the three-dimensional shape of the object.

In the present disclosure, an autonomous moving body control system that causes an autonomous moving body, equipped with a sensor that measures a three-dimensional shape of an object in a region, to travel, and reproduces the three-dimensional shape of the object, includes a route creation unit that creates a route over which the autonomous moving body is to travel in the region, a traveling control unit that causes the autonomous moving body to travel in the region along the route that is created, an information acquisition unit that acquires the three-dimensional shape of the object measured by the sensor while the autonomous moving body is traveling, and a route changing unit that changes the route over which the autonomous moving body travels in the region, such that the autonomous moving body approaches the object, based on the three-dimensional shape of the object acquired while the autonomous moving body is traveling, in which the traveling control unit causes the autonomous moving body to travel in the region along the route that is changed, and the information acquisition unit acquires the three-dimensional shape of the object measured by the sensor while the autonomous moving body is traveling in the region along the route that is changed.

According to such a configuration, the distance between the autonomous moving body and the object is adjusted in accordance with the three-dimensional shape of the object, and the three-dimensional shape of the object is efficiently and accurately reproduced.

When a spatial portion is present that is not viewable from above in a three-dimensional range that is overlapped by the object as viewed in an up-down direction, the route changing unit changes the route over which the autonomous moving body travels in the region such that the autonomous moving body approaches the spatial portion. According to such a configuration, when there is such a spatial portion and the three-dimensional shape of the object is complicated, the autonomous moving body is brought close to the spatial portion and the three-dimensional shape of the object is measured using the sensor, and accordingly the three-dimensional shape can be accurately reproduced even when the object has a complicated three-dimensional shape.

The autonomous moving body control system further includes a sensor control unit that controls a position of the sensor, in which the sensor control unit controls the position of the sensor such that the sensor enters the spatial portion while the autonomous moving body is traveling in the region along the route that is changed. According to such a configuration, the sensor is brought close to a part of the object with a complicated three-dimensional shape to measure the three-dimensional shape of the object, and accordingly the three-dimensional shape can be reproduced more accurately even when the object has a complicated three-dimensional shape.

In the present disclosure, an autonomous moving body control method that causes an autonomous moving body, equipped with a sensor that measures a three-dimensional shape of an object in a region, to travel, and reproduces the three-dimensional shape of the object, includes creating a route over which the autonomous moving body is to travel in the region, causing the autonomous moving body to travel in the region along the route that is created, acquiring the three-dimensional shape of the object measured by the sensor while the autonomous moving body is traveling, changing the route over which the autonomous moving body travels in the region, such that the autonomous moving body approaches the object, based on the three-dimensional shape of the object acquired while the autonomous moving body is traveling, causing the autonomous moving body to travel in the region along the route that is changed, and acquiring the three-dimensional shape of the object measured by the sensor while the autonomous moving body is traveling in the region along the route that is changed.

According to such a configuration, the distance between the autonomous moving body and the object is adjusted in accordance with the three-dimensional shape of the object, and the three-dimensional shape of the object is efficiently and accurately reproduced.

In the present disclosure, a storage medium stores a program for controlling an autonomous moving body control system that causes an autonomous moving body, equipped with a sensor that measures a three-dimensional shape of an object in a region, to travel, and reproduces the three-dimensional shape of the object. The program causes the autonomous moving body control system to execute creating a route over which the autonomous moving body is to travel in the region, causing the autonomous moving body to travel in the region along the route that is created, acquiring the three-dimensional shape of the object measured by the sensor while the autonomous moving body is traveling, changing the route over which the autonomous moving body travels in the region, such that the autonomous moving body approaches the object, based on the three-dimensional shape of the object acquired while the autonomous moving body is traveling, causing the autonomous moving body to travel in the region along the route that is changed, and acquiring the three-dimensional shape of the object measured by the sensor while the autonomous moving body is traveling in the region along the route that is changed.

According to such a configuration, the distance between the autonomous moving body and the object is adjusted in accordance with the three-dimensional shape of the object, and the three-dimensional shape of the object is efficiently and accurately reproduced.

The route creation unit may use a learning model obtained by machine learning to create the route for the region in which the autonomous moving body is to travel.

The present disclosure can provide an autonomous moving body control system, an autonomous moving body control method, and a storage medium, that adjust distance between the autonomous moving body and an object in accordance with the three-dimensional shape of the object, thereby efficiently and accurately reproducing the three-dimensional shape of the object.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a system configuration diagram of an autonomous moving body control system according to an embodiment;

FIG. 2 is a schematic perspective view of an autonomous traveling robot;

FIG. 3 is a functional block diagram of a control unit of the autonomous traveling robot and a cloud server;

FIG. 4 is a flowchart of a control program executed by a first control unit and a second control unit; and

FIG. 5 is a schematic perspective view of a region a illustrated in FIG. 1.

### DETAILED DESCRIPTION OF EMBODIMENTS

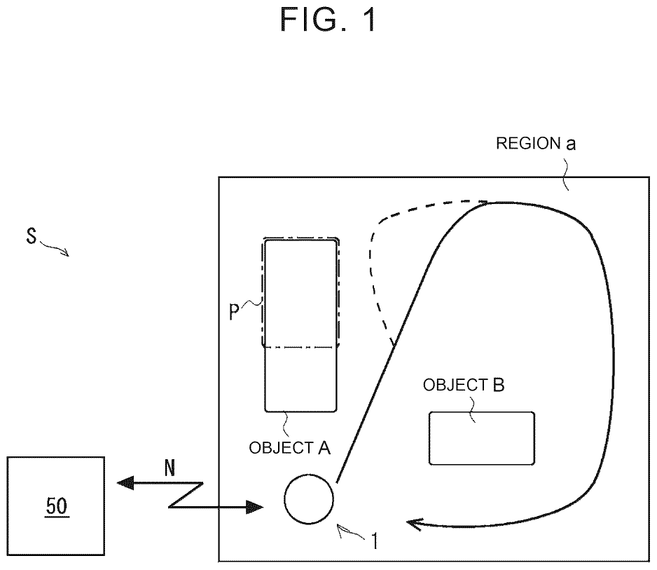

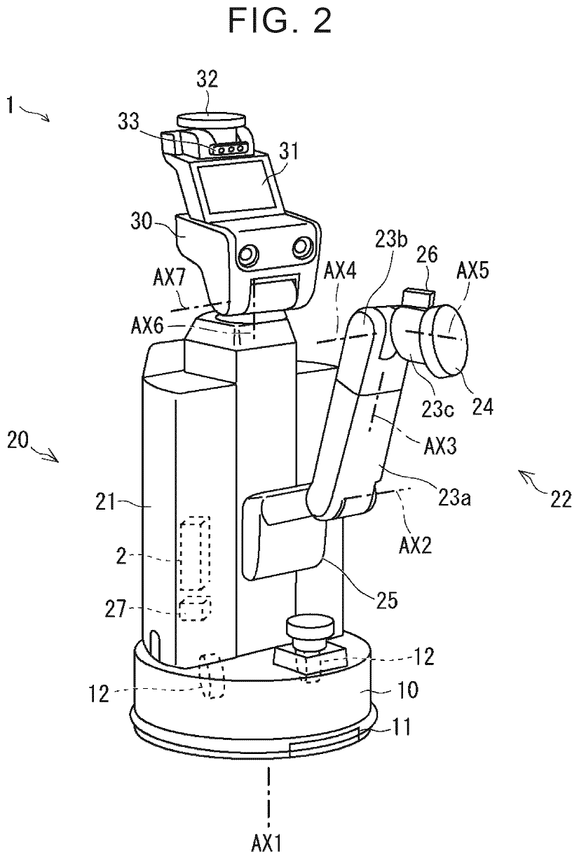

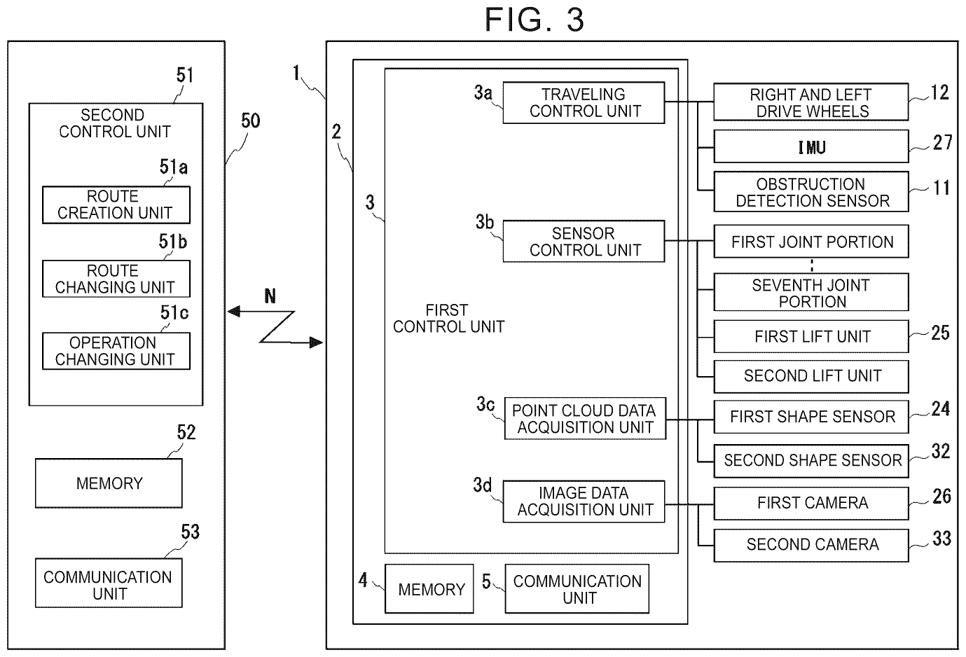

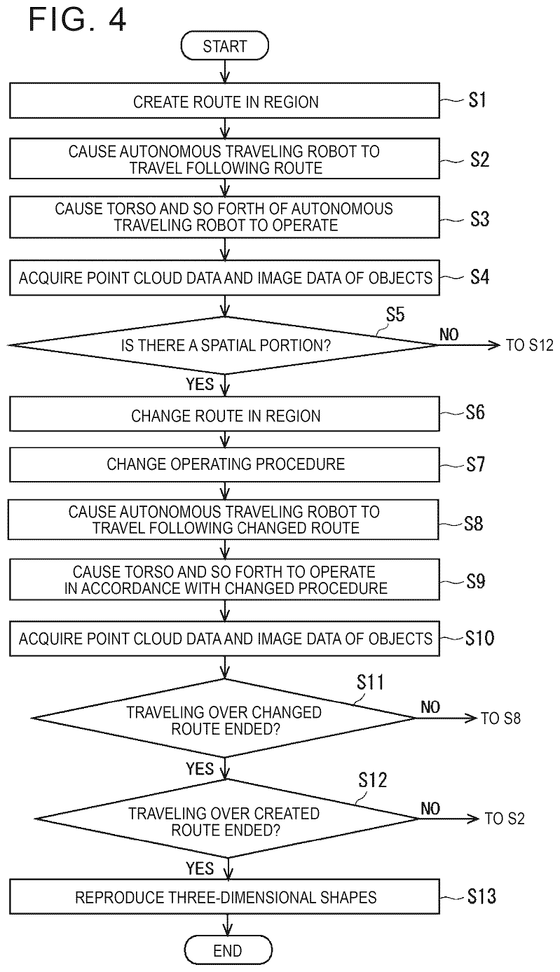

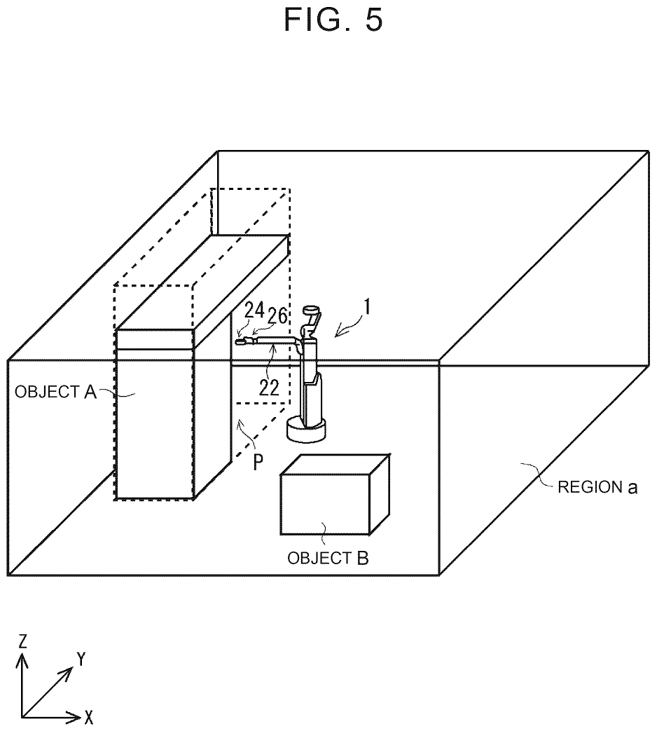

The present disclosure will be described below with reference to FIGS. 1 to 5. FIG. 1 is a system configuration diagram of an autonomous moving body control system according to an embodiment. FIG. 2 is a schematic perspective view of an autonomous traveling robot. FIG. 3 is a functional block diagram of a control unit of the autonomous traveling robot and a cloud server. FIG. 4 is a flowchart of a control program executed by a first control unit and a second control unit. FIG. 5 is a schematic perspective view of a region a illustrated in FIG. 1.

Note that the right-handed XYZ orthogonal coordinate system in FIG. 5 is provided merely for convenience in describing positional relations among components, as a matter of course. In FIG. 5, a positive Z-axis direction is upward in an up-down direction, and an XY plane is a horizontal plane.

### First Embodiment

A system configuration of an autonomous moving body control system S according to a first embodiment will be described with reference to FIG. 1. A region a is a region in which a three-dimensional shape of an object is to be reproduced. An object A and an object B are disposed in the region a, and FIG. 1 illustrates the planar shapes of the object A and the object B as viewed from above. In the autonomous moving body control system S, an autonomous traveling robot 1 is caused to travel in the region a along a route indicated by a solid line arrow, to measure the three-dimensional shape of the object A and so forth. The autonomous traveling robot 1 and a cloud server 50 are connected via a communication network N, and the cloud server 50 reproduces the three-dimensional shape of the object A and so forth, based on the three-dimensional shape of the object A and so forth as measured by the autonomous traveling robot 1.

Next, the autonomous traveling robot 1 will be described with reference to FIG. 2. The autonomous traveling robot 1 is an autonomous moving body that is equipped with a sensor that measures the three-dimensional shape of objects, and has a bogie unit 10, a torso unit 20, and a head unit 30.

The bogie unit 10 includes, for example, right and left drive wheels 12 and one caster (omitted from illustrating) in a cylindrical housing, and the right and left drive wheels 12 are independently driven and controlled by respective motors. This enables the bogie unit 10 to travel in an optional direction over a floor surface. It should be noted that the robot may be ambulatory, using a plurality of legs instead of the drive wheels 12.

Obstruction detection sensors 11 are each provided on front and rear sides of the bogie unit 10 (obstruction detection sensor on rear side is omitted from illustration). The obstruction detection sensors 11 are sensors that detect obstructions on the route along which the autonomous traveling robot 1 travels, examples of which include a Lidar sensor, a millimeter wave radar sensor, a radar sensor, an ultrasonic sensor, a depth sensor, and so forth.

The torso unit 20 has a torso 21 and an arm unit 22. The torso 21 is formed in a semi-cylindrical shape and extends in the up-down direction. The torso 21 and the bogie unit 10 are formed with a first joint portion (omitted from illustration) that links therebetween, and the torso 21 can be turned in a horizontal direction about a first linking axis AX1 of the first joint portion by a motor. Also, a first lift unit 25 is provided between the arm unit 22 and the torso 21, and the arm unit 22 can be raised and lowered in the up-down direction by the first lift unit 25. Note that although one arm unit 22 is provided in the embodiment, a plurality of arm units may be provided.

The arm unit 22 is disposed on a front side of the torso 21 and includes a first arm portion 23a, a second arm portion 23b, a wrist portion 23c, a first shape sensor 24, and a first camera 26.

The first arm portion 23a is provided on the torso 21 side of the arm unit 22. The first arm portion 23a and the first lift unit 25 are formed with a second joint portion (omitted from illustration) that links therebetween, and the first arm portion 23a can be turned in the up-down direction about a second linking axis AX2 of the second joint portion by a motor.

The second arm portion 23b is linked to a distal end of the first arm portion 23a on a side opposite to the torso 21. The second arm portion 23b and the first arm portion 23a are formed with a third joint portion (omitted from illustration) that links therebetween, and the second arm portion 23b can be turned in a torsional direction about a third linking axis AX3 of the third joint portion by a motor.

The wrist portion 23c is linked to a distal end of the second arm portion 23b on a side opposite from the first arm portion 23a. The wrist portion 23c and the second arm portion 23b are formed with a fourth joint portion (omitted from illustration) that links therebetween, and the wrist portion 23c can be turned in the up-down direction and so forth about a fourth linking axis AX4 of the fourth joint portion by a motor. The wrist portion 23c and the second arm portion 23b are further formed with a fifth joint portion (omitted from illustration) that links therebetween, and the wrist portion 23c can be turned in the torsional direction about a fifth linking axis AX5 of the fifth joint portion by a motor.

The first shape sensor 24 is attached to a distal end of the wrist portion 23c on a side opposite to the second arm portion 23b. The first shape sensor 24 is a sensor that measures three-dimensional shapes of objects around the autonomous traveling robot 1 as point cloud data, examples of which include a Lidar sensor, a millimeter wave radar sensor, a radar sensor, an ultrasonic sensor, and a depth sensor.

The first camera 26 is attached to the wrist portion 23c. The first camera 26 is a camera that shoots objects around the autonomous traveling robot 1, examples of which include a monocular camera and a multi-lens camera.

The torso 21 has an inertial measurement unit (IMU) 27 built in. The IMU 27 is an inertial measurement unit that measures the current position of the autonomous traveling robot 1.

The head unit 30 has a display 31, a second shape sensor 32, and a second camera 33. The head unit 30 and the torso 21 are formed with a sixth joint portion (omitted from illustration) that links therebetween, and the head unit 30 can be turned in the horizontal direction about a sixth linking axis AX6 of the sixth joint portion by a motor. Also, the head unit 30 and the torso 21 are formed with a seventh joint portion (omitted from illustration) that links therebetween, and the head unit 30 can be turned in the up-down direction about a seventh linking axis AX7 of the seventh joint portion by a motor. Furthermore, a second lift unit (omitted from illustration) is provided between the head unit 30 and the torso 21, and the head unit 30 can be raised and lowered in the up-down direction by the second lift unit.

A touch panel liquid crystal display, for example, is applied as the display 31. The display 31 is used to display information regarding the autonomous traveling robot 1 to the user, or to input instructions from the user to the autonomous traveling robot 1, and so forth.

The second shape sensor 32 is attached to an uppermost portion of the head unit 30. The second shape sensor 32 has the same structure and functions as the first shape sensor 24, and accordingly description thereof will be omitted. The second camera 33 is attached between the display 31 of the head unit 30 and the second shape sensor 32. The second camera 33 has the same structure and function as the first camera 26, and accordingly description thereof will be omitted.

Next, functions of a robot control unit 2 built into the autonomous traveling robot 1 will be described with reference to FIG. 3. The robot control unit 2 is built into the torso 21 of the autonomous traveling robot 1.

The robot control unit 2 includes a first control unit 3, memory (a storage medium) 4, and a communication unit 5. The first control unit 3 includes a central processing unit (CPU), a graphics processing unit (GPU), or the like, and controls the right and left drive wheels 12 and so forth. The memory 4 includes random access memory (RAM), read-only memory (ROM), a solid state drive (SSD), and so forth, and stores a control program and so forth for the autonomous traveling robot 1, such as operation procedures or the like for the torso 21 and so forth for when the autonomous traveling robot 1 is traveling. The communication unit 5 is communicatively connected to the communication network N, and is connected to the cloud server 50 via a mobile telephone line (e.g., 4G or 5G), Bluetooth (registered trademark), WiFi (Wireless Fidelity), or the like.

The first control unit 3 includes a traveling control unit 3a, a sensor control unit 3b, a point cloud data acquisition unit 3 c, and an image data acquisition unit 3d. The traveling control unit 3a transmits control signals to the motors of the right

and left drive wheels 12 to cause the right and left drive wheels 12 to travel in an optional direction. The traveling control unit 3a causes the autonomous traveling robot 1 to travel in a region along a route created by a route creation unit 51a, which will be described later. The traveling control unit 3a acquires the current position of the autonomous traveling robot 1 that is measured by the IMU 27, and controls the autonomous traveling robot 1 so as to travel in the region along the route created by the route creation unit 51a. The traveling control unit 3a controls the robot to circumvent obstructions when the obstruction detection sensor 11 detects the obstructions.

The sensor control unit 3b transmits control signals to the first joint portion through the seventh joint portion, the first lift unit 25, and the second lift unit, to turn and to raise and lower the torso 21, the first arm portion 23a, the second arm portion 23b, the wrist portion 23c, and the head unit 30, in optional directions. When the torso 21 or the like is turned or the like, positions and orientations of the first shape sensor 24 and the second shape sensor 32 change. In this way, the sensor control unit 3b controls the positions and the orientations of the first shape sensor 24 and the second shape sensor 32. At the same time, the sensor control unit 3b controls the positions and the orientations of the first camera 26 and the second camera 33.

The sensor control unit 3b operates the torso 21 and so forth such that the first shape sensor 24, the first camera 26, and so forth, can measure the three-dimensional shapes of objects around the autonomous traveling robot 1 while the autonomous traveling robot 1 is traveling in the region along the route created by the route creation unit 51a described below. Specifically, the sensor control unit 3b transmits a control signal to the first joint portion and so forth, in accordance with a procedure stored in the memory 4 in advance, such that the torso 21 and so forth operate while the autonomous traveling robot 1 travels in the region along the route created by the route creation unit 51a.

The point cloud data acquisition unit 3c acquires point cloud data, which is a three-dimensional shape of an object measured by the first shape sensor 24 and the second shape sensor 32, at predetermined timings, while the autonomous traveling robot 1 is traveling in the region along the route created by the route creation unit 51a. The point cloud data acquisition unit 3c functions as an information acquisition unit that acquires three-dimensional shapes of objects measured by the first shape sensor 24 and the second shape sensor 32 while the autonomous traveling robot 1 is traveling in the region along the route created by the route creation unit 51a. In the first embodiment, two shape sensors are provided, and the two sensors apportion parts of the measurement range and perform measurement thereof. The number of shape sensors is not limited to two, and one, or three or more, may be provided.

The timing at which the point cloud data acquisition unit 3c acquires point cloud data from the first shape sensor 24 and so forth is synchronized with the positions and the orientations of the first shape sensor 24 and the second shape sensor 32 that are controlled by the sensor control unit 3b. That is to say, the point cloud data acquisition unit 3c acquires the point cloud data from the first shape sensor 24 and so forth, in accordance with the positions and the orientations of the first shape sensor 24 and the second shape sensor 32. The point cloud data acquisition unit 3c acquires the point cloud data in accordance with the position and the orientation of the first shape sensor 24 and so forth, and accordingly a second control unit 51 that will be described later integrates a plurality of pieces of the point cloud data acquired by the point cloud data acquisition unit 3c to reproduce the three-dimensional shapes of the objects.

The image data acquisition unit 3d acquires image data of objects shot by the first camera 26 and the second camera 33 at predetermined timings while the autonomous traveling robot 1 is traveling in the region along the route created by the route creation unit 51a. The image data includes three-dimensional shapes of the objects, and accordingly the image data acquisition unit 3d functions as an information acquisition unit that acquires the three-dimensional shapes of the objects measured by the first camera 26 and the second camera 33 while the autonomous traveling robot 1 is traveling in the region along the route created by the route creation unit 51a. In the first embodiment, two cameras are provided, and the two cameras apportion parts of the shooting range and perform shooting thereof. The number of cameras is not limited to two, and one, or three or more, may be provided.

The timing at which the image data acquisition unit 3d acquires image data from the first camera 26 and so forth is synchronized with the positions and the orientations of the first camera 26 and the second camera 33 that are controlled by the sensor control unit 3b. That is to say, the image data acquisition unit 3d acquires image data from the first camera 26 and so forth, in accordance with the positions and the orientations of the first camera 26 and the second camera 33. The image data acquisition unit 3d acquires image data in accordance with the position and the orientation of the first camera 26 and so forth, and accordingly the second control unit 51 that will be described later integrates a plurality of pieces of the image data acquired by the image data acquisition unit 3d to reproduce the three-dimensional shapes of the objects.

The timing at which the point cloud data acquisition unit 3c acquires the point cloud data and the timing at which the image data acquisition unit 3d acquires the image data may be the same or may be different. In the first embodiment, a time interval for acquiring image data is set to be longer than a time interval for acquiring point cloud data.

Next, the functions of the cloud server 50 making up the autonomous moving body control system S according to the first embodiment will be described with reference to FIG. 3. The cloud server 50 includes the second control unit 51, memory (a storage medium) 52, and a communication unit 53.

The second control unit 51 includes a CPU, a GPU, and so forth, and performs tasks such as creating a route in the region in which the autonomous traveling robot 1 travels, and so forth. The memory 52 includes RAM, ROM, an SSD, and so forth, and stores the control program for the autonomous traveling robot 1, data regarding the size of each of three-dimensional directions of the region for reproducing three-dimensional shapes of objects, and so forth. The communication unit 53 is communicably connected to the communication network N, and is connected to the autonomous traveling robot 1 via a mobile telephone line, Bluetooth (registered trademark), WIFI, or the like.

The second control unit 51 includes the route creation unit 51a, a route changing unit 51b, and an operation changing unit 51c. The route creation unit 51a creates a route in the region in which the autonomous traveling robot 1 is to travel. Specifically, data regarding the three-dimensional sizes of the region in which three-dimensional shapes of objects are to be reproduced, and planar shapes and layout of facility machinery and so forth in the region as viewed from above, is stored in memory 52 in advance, and based on this data, the route creation unit 51a creates a route for the region in which the autonomous traveling robot 1 is to travel. The route creation unit 51a creates a route over which to travel in the region, using a known method such as Dijkstra's algorithm, the Easter algorithm, the Voronoi diagram, and so forth. When the distance between the first shape sensor 24 and so forth and the objects is too close, error readily occurs in the measured point cloud data, and accordingly a plurality of routes is created using a known method, for example, and when there is a route that gradually moves away from the objects, that route is selected.

The route changing unit 51b changes the route in the region in which the autonomous traveling robot 1 is traveling, such that the autonomous traveling robot 1 approaches the objects based on the point cloud data and so forth of the objects acquired by the point cloud data acquisition unit 3c while the autonomous traveling robot 1 is traveling along the route in the region created by the route creation unit 51a. That is to say, the route changing unit 51b changes the route in the region in which the autonomous moving body travels, such that the autonomous moving body approaches the objects, based on the three-dimensional shapes of the objects acquired while the autonomous moving body is traveling. Specifically, while the autonomous traveling robot 1 is traveling in the region along the route created by the route creation unit 51a, when there is a spatial portion that cannot be seen from above in a three-dimensional range that is overlapped by an object as viewed from the up-down direction, the route in the region, in which the autonomous traveling robot 1 is traveling, is changed such that the autonomous traveling robot 1 approaches this spatial portion.

The operation changing unit 51c changes the operation procedures of the torso 21 and so forth of the autonomous traveling robot 1 such that the first shape sensor 24 and the first camera 26 enter this spatial portion, while the autonomous traveling robot 1 is traveling in the region along the route changed by the route changing unit 51b.

Next, the control program for the autonomous traveling robot 1 executed by the first control unit 3 of the autonomous traveling robot 1 and the second control unit 51 of the cloud server 50 will be described. FIG. 4 shows a flowchart of the control program of the autonomous traveling robot 1 executed by the first control unit 3 and the second control unit 51.

Before the control program is executed by the first control unit 3 and the second control unit 51, an input device that is omitted from illustration is used to input data into the memory 52 of the cloud server 50, such as the three-dimensional sizes of the region a from which the three-dimensional shapes of the objects are to be reproduced, and data and so forth regarding the planar shapes and the layout of the facility machinery and so forth in the region a as viewed from above. After entering this data into the memory 52, the control program is started.

In step S1, the route creation unit 51a of the second control unit 51 creates a route in the region a in which the autonomous traveling robot 1 is to travel. For example, a route for the region a is created as indicated by the solid line arrow in FIG. 1. The second control unit 51 transmits the route created by the route creation unit 51a in the region a to the autonomous traveling robot 1 via the communication unit 53.

In step S2, the traveling control unit 3a of the first control unit 3 transmits control signals to each of the motors of the right and left drive wheels 12, such that the autonomous traveling robot 1 travels in the region a along the route created by the route creation unit 51a. The autonomous traveling robot 1 travels in the region a along the route created by the route creation unit 51a.

In step S3, while the autonomous traveling robot 1 is traveling in the region a along the route created by the route creation unit 51a, the sensor control unit 3b of the first control unit 3 operates the torso 21 and so forth, such that the first shape sensor 24, the first camera 26, and so forth, can measure the three-dimensional shapes of the objects around the autonomous traveling robot 1. Specifically, the sensor control unit 3b transmits control signals to the first joint portion through the seventh joint portion, the first lift unit 25, and the second lifting unit, in accordance with procedures stored in the memory 4 in advance, such that the torso 21 and so forth operate while the autonomous traveling robot 1 travels in the region a along the route created by the route creation unit 51a.

In step S4, while the autonomous traveling robot 1 is traveling in the region a along the route created by the route creation unit 51a, the point cloud data acquisition unit 3c of the first control unit 3 acquires point cloud data of the objects measured by the first shape sensor 24 and the second shape sensor 32. Also, in step S4, while the autonomous traveling robot 1 is traveling in the region a along the route created by the route creation unit 51a, the image data acquisition unit 3d acquires image data of the objects shot by the first camera 26 and the second camera 33. The first control unit 3 transmits the point cloud data of the objects acquired by the point cloud data acquisition unit 3c, and the image data of the objects acquired by the image data acquisition unit 3d, to the cloud server 50 via the communication unit 5.

In step S5, based on the point cloud data acquired by the point cloud data acquisition unit 3 c and the image data acquired by the image data acquisition unit 3d, the second control unit 51 determines whether there is a spatial portion that cannot be seen from above in the three-dimensional range that is overlapped by an object when viewed in the up-down direction. For example, as illustrated in FIG. 5, determination is made whether there is a spatial portion that cannot be seen from above in the three-dimensional range (range surrounded by dashed lines) that is overlapped by the object A when viewed in the up-down direction (viewed in the Z-axis direction). Note that in FIG. 5, the dashed lines are shifted from their actual positions to make the three-dimensional range easier to see. In the three-dimensional range that is overlapped by the object A when viewed in the up-down direction, there is a spatial portion P that cannot be seen from above on a far side in the region a (positive Y-axis direction side in FIG. 5).

As illustrated in FIG. 5, the spatial portion includes not only situations in which the entire space is open in one direction of the object A (X-axis direction in FIG. 5), but also situations in which only a part of the space is open. Also, in order to insert the first shape sensor 24 and so forth into the spatial portion at a later time, determination is made in step S5 there is a spatial portion when the spatial portion is large enough for the first shape sensor 24 and so forth to enter. Accordingly, when there is a spatial portion but the size of the spatial portion is not large enough for the first shape sensor 24 and the like to enter, determination is made in step S5 that there is no spatial portion. When determination is made in step S5 that there is a spatial portion, the processing advances to step S6, and when determination is made that there is no spatial portion, the processing advances to step S12.

In step S6, the route changing unit 51b of the second control unit 51 changes the route in the region a that the route creation unit 51a created in step S1. Specifically, in order to enable the first shape sensor 24 and the first camera 26 to enter the spatial portion P, the route over which the autonomous traveling robot 1 travels in the region a is changed such that the autonomous traveling robot 1 approaches the spatial portion P of the object A, as indicated by the dashed line in FIG. 1. The distance to which the arm unit 22 can approach is determined based on the size of the spatial portion P and the length thereof that can be extended. For example, when the length of the spatial portion P in a width direction (X-axis direction in FIG. 5) is long, the autonomous traveling robot 1 is made to approach closer to the spatial portion P than when the length is short. The second control unit 51 transmits the route in the region a changed by the route changing unit 51b to the autonomous traveling robot 1 via the communication unit 53.

Next, in step S7, the operation changing unit 51c of the second control unit 51 changes the operation procedures of the torso 21 and so forth of the autonomous traveling robot 1, such that the first shape sensor 24 and the first camera 26 enter the spatial portion P while the autonomous traveling robot 1 is traveling in the region a along the route changed by the route changing unit 51b. Specifically, as illustrated in FIG. 5, the operation procedures of the torso 21 and so forth of the autonomous traveling robot 1 are changed such that the arm unit 22 of the autonomous traveling robot 1 is extended, and the first shape sensor 24 and the first camera 26 enter the spatial portion P. Also, the operating procedures of the torso 21 and so forth of the autonomous traveling robot 1 are changed such that, after the first shape sensor 24 and the first camera 26 enter the spatial portion P, the second arm portion 23b and the wrist portion 23c are turned, such that point cloud data and image data of the object can be acquired from the spatial portion P. The second control unit 51 transmits the operation procedure of the torso 21 and so forth, changed by the operation changing unit 51c, to the autonomous traveling robot 1 via the communication unit 53.

In step S8, the traveling control unit 3a of the first control unit 3 transmits control signals to each motor of the right and left drive wheels 12 such that the autonomous traveling robot 1 travels in the region a along the route changed by the route changing unit 51b.

In step S9, the sensor control unit 3b of the first control unit 3 operates the torso 21 and so forth in accordance with the procedures changed by the operation changing unit 51c such that the first shape sensor 24 and the first camera 26 enter the spatial portion P while the autonomous traveling robot 1 is traveling in the region a along the route changed by the route changing unit 51b.

In step S10, while the autonomous traveling robot 1 is traveling in the region a along the route changed by the route changing unit 51b, the point cloud data acquisition unit 3c of the first control unit 3 acquires point cloud data of the objects measured by the first shape sensor 24 and the second shape sensor 32. Also, in step S10, the image data acquisition unit 3d acquires image data of objects shot by the first camera 26 and the second camera 33 while the autonomous traveling robot 1 is traveling in the region a along the route changed by the route changing unit 51b. The first control unit 3 transmits the point cloud data of the objects acquired by the point cloud data acquisition unit 3c, and the image data of the objects acquired by the image data acquisition unit 3d, to the cloud server 50 via the communication unit 5.

In step S11, the first control unit 3 determines, based on the current position of the autonomous traveling robot 1 measured by the IMU 27, whether traveling in the region a along the route changed by the route changing unit 51b has ended. When not ended, the processing returns to step S8 and is repeated, and when ended, the processing advances to step S12.

In step S12, the first control unit 3 determines, based on the current position of the autonomous traveling robot 1 measured by the IMU 27, whether traveling in the region a along the route created by the route creation unit 51a has ended. When not ended, the processing returns to step S2 and is repeated, and when ended, the processing advances to step S13.

In step S13, the second control unit 51 reproduces the three-dimensional shapes of the objects in the region a. Specifically, while the autonomous traveling robot 1 is traveling in the region a along the route created by the route creation unit 51a, and in the region a along the route changed by the route changing unit 51b, the three-dimensional shapes of the objects are reproduced using a known method based on the point cloud data acquired by the point cloud data acquisition unit 3c and the image data acquired by the image data acquisition unit 3d. Once the reproduction is complete, the reproduced three-dimensional shapes are displayed on a display device that is omitted from illustration, or stored as data in the memory 52.

In the embodiment, while the autonomous traveling robot 1 is traveling in the region a along the route created by the route creation unit 51a, the route changing unit 51b changes the route along which the autonomous traveling robot 1 is traveling in the region a such that the autonomous traveling robot 1 approaches the objects based on the point cloud data and the image data of the objects that are acquired. Also, while the autonomous traveling robot 1 is traveling in the region a along the route that is changed, the point cloud data acquisition unit 3c acquires point cloud data of the objects, and the image data acquisition unit 3d acquires image data of the objects. By having such a configuration, the distance between the autonomous traveling robot 1 and the objects is adjusted in accordance with the three-dimensional shapes of the objects, and the three-dimensional shapes of the objects are measured using the first shape sensor 24 and the first camera 26, such that the three-dimensional shapes of the objects can be efficiently and accurately reproduced.

In the embodiment, when there is a spatial portion P that cannot be seen from above in the three-dimensional range that is overlapped by an object as viewed the up-down direction, the route changing unit 51b changes the route of over which the autonomous traveling robot 1 travels in the region a such that the autonomous traveling robot 1 approaches the spatial portion P. By having such a configuration, when there is the spatial portion P and the three-dimensional shape of the object is complicated, the autonomous traveling robot 1 is brought close to the spatial portion P and the three-dimensional shape of the object is measured using the first shape sensor 24 and the first camera 26, such that the three-dimensional shape can be accurately reproduced even when the object has a complicated three-dimensional shape.

In the embodiment, the sensor control unit 3b controls the positions of the first shape sensor 24 and the first camera 26 such that the first shape sensor 24 and the first camera 26 enter the spatial portion P while the autonomous traveling robot 1 is traveling in the region a along the route that is changed. By having such a configuration, the first shape sensor 24 and the first camera 26 are brought close to the part with a complicated three-dimensional shape to measure the three-dimensional shape of the object, and accordingly the three-dimensional shape can be reproduced more accurately even when the object has a complicated three-dimensional shape.

Note that the present disclosure is not limited to the above-described embodiment, and can be modified as appropriate without departing from the spirit and scope thereof.

For example, the autonomous moving body may be a moving body that can move in the air, such as a drone or the like.

In addition to controlling the position and the orientation of the sensor using the joint portions, the lift unit, and so forth, of the autonomous moving body, portions equipped with sensors, such as a slave drones, may also be separated from the autonomous moving body.

In the embodiment, the autonomous moving body is described as being separately controlled by the first control unit and the second control unit, but may be controlled by a single integrated control unit.

In the embodiment, the three-dimensional shapes of objects are described as being measured using shape sensors and cameras, but an arrangement may be made in which just one thereof is used.

In the embodiment, a cloud server is described as being used, but other servers, such as a dedicated server or the like, may also be used.

What is claimed is:

1. An autonomous moving body control system that causes an autonomous moving body, equipped with a sensor that measures a three-dimensional shape of an object in a region, to travel, and reproduces the three-dimensional shape of the object, the autonomous moving body control system comprising:
a route creation unit that creates a route over which the autonomous moving body is to travel in the region;
a traveling control unit that causes the autonomous moving body to travel in the region along the route that is created;
an information acquisition unit that acquires the three-dimensional shape of the object measured by the sensor while the autonomous moving body is traveling; and
a route changing unit that changes the route over which the autonomous moving body travels in the region, such that the autonomous moving body approaches the object, based on the three-dimensional shape of the object acquired while the autonomous moving body is traveling, wherein
the traveling control unit causes the autonomous moving body to travel in the region along the route that is changed, and
the information acquisition unit acquires the three-dimensional shape of the object measured by the sensor while the autonomous moving body is traveling in the region along the route that is changed.

2. The autonomous moving body control system according to claim 1, wherein, when a spatial portion is present that is not viewable from above in a three-dimensional range that is overlapped by the object as viewed in an up-down direction, the route changing unit changes the route over which the autonomous moving body travels in the region such that the autonomous moving body approaches the spatial portion.

3. The autonomous moving body control system according to claim 2, further comprising a sensor control unit that controls a position of the sensor, wherein the sensor control unit controls the position of the sensor such that the sensor enters the spatial portion while the autonomous moving body is traveling in the region along the route that is changed.

4. An autonomous moving body control method that causes an autonomous moving body, equipped with a sensor that measures a three-dimensional shape of an object in a region, to travel, and reproduces the three-dimensional shape of the object, the autonomous moving body control method comprising:
creating a route over which the autonomous moving body is to travel in the region;
causing the autonomous moving body to travel in the region along the route that is created;
acquiring the three-dimensional shape of the object measured by the sensor while the autonomous moving body is traveling;
changing the route over which the autonomous moving body travels in the region, such that the autonomous moving body approaches the object, based on the three-dimensional shape of the object acquired while the autonomous moving body is traveling;
causing the autonomous moving body to travel in the region along the route that is changed; and
acquiring the three-dimensional shape of the object measured by the sensor while the autonomous moving body is traveling in the region along the route that is changed.

5. A non-transitory storage medium storing a program for controlling an autonomous moving body control system that causes an autonomous moving body, equipped with a sensor that measures a three-dimensional shape of an object in a region, to travel, and reproduces the three-dimensional shape of the object, the program causing the autonomous moving body control system to execute:
creating a route over which the autonomous moving body is to travel in the region;
causing the autonomous moving body to travel in the region along the route that is created;
acquiring the three-dimensional shape of the object measured by the sensor while the autonomous moving body is traveling;
changing the route over which the autonomous moving body travels in the region, such that the autonomous moving body approaches the object, based on the three-dimensional shape of the object acquired while the autonomous moving body is traveling;
causing the autonomous moving body to travel in the region along the route that is changed; and
acquiring the three-dimensional shape of the object measured by the sensor while the autonomous moving body is traveling in the region along the route that is changed.
